(19) United States
(12) Patent Application Publication
(10) Pub. No.: US 2026/0139897 A1
(43) Pub. Date: May 21, 2026

(54) COOLING DEVICE AND WATER PURIFIER COMPRISING SAME

(71) Applicant: COWAY CO., LTD., Gongju-si (KR)

(72) Inventors: Jae Man KIM, Gongju-si (KR); Woong JUNG, Gongju-si (KR)

(73) Assignee: COWAY CO., LTD., Gongju-si (KR)

(21) Appl. No.: 19/118,845

(22) PCT Filed: Aug. 31, 2023
(86) PCT No.: PCT/KR2023/013024

§ 371 Date: Apr. 7, 2025

(30) Foreign Application Priority Data
Nov. 3, 2022 (KR) 10-2022-0145082

(51) Int. Cl. F25D 31/00; B67D 1/08

(52) U.S. Cl. CPC F25D 31/002; B67D 1/0869; B67D 2210/0001; B67D 2210/00049

(57) ABSTRACT

Disclosed are a cooling device and a water purifier comprising same. The cooling device, according to one aspect of the present disclosure, comprises: a cooling flow path of having a fluid flowing therein; a cooling frame making contact with the cooling flow path so as to carry out heat-exchange in order to cool the fluid flowing in the cooling flow path; and a cooling module coupled with the cooling frame so as to cool the cooling frame by receiving heat transferred to the cooling frame. The cooling flow path comprises: a first cooling flow path wound outside the cooling frame and fluidly connected to the outside so as to form one portion of the flow path in which the fluid is flowing; and a second cooling flow path wound inside the cooling frame and fluidly connected to the first cooling flow path and the outside so as to form the other portion of the flow path in which the fluid is flowing. A flow path receiving part for receiving a portion of the outer circumference of the first cooling flow path may be formed on the outer circumference of the cooling frame.

### TECHNICAL FIELD

The present disclosure relates to a cooling device and a water purifier including the same, and more particularly, to a cooling device having a structure capable of improving heat-exchange efficiency and cooling efficiency while miniaturizing and reducing the weight of the product, and a water purifier including the same.

### BACKGROUND ART

A water purifier is a generic term of any device that can receive raw water, process it in a desired state, and then provide it to a user. The water purifier can filter the raw water using various types of filters and provide it to the user. For example, the water purifier can filter the raw water so that it is suitable for drinking and provide it to the user.

As the standard of living improves, and user demands diversify, recently, the water purifier that can perform additional functions in addition to simply filtering the raw water and providing it to the user is popular. For example, recently, the water purifier that can provide hot water, cold-water, and even ice to the user is marketed and sold in popularity.

In general, the water purifier for discharging cold-water is equipped with a tank for receiving purified water and a configuration for heating the purified water contained in the tank. The above-mentioned type of water purifier may be referred to as a tank-type water purifier. In the case of a tank-type water purifier, a large amount of cold-water can be discharged at a time, and thus it is widely used.

By the way, if the discharge of cold-water is not frequent, there is a concern that the cold-water contained in the tank may stagnate. In this case, there is a fear that contamination by microorganisms, etc. may occur inside the tank, and thus cold-water in an unclean state may be provided to the user. This may cause a decrease in the reliability of the purified water of the water purifier, thereby reducing user satisfaction.

To solve the problem, a separate configuration may be provided for periodically discharging cold-water contained in the tank or sterilizing the cold-water. However, in order to provide the above-mentioned separate configuration, additional space for accommodating them and additional configuration for controlling them are required. This can lead to an increase in the volume of the water purifier and a complexity of the structure.

Recently, a direct water-type water purifier that cools and discharges purified water directly according to the user's needs without the tank for receiving cold-water is on the market. However, in the case of such a direct water-type water purifier, there is a limitation in the amount of water that can be cooled during continuous water discharge. Therefore, there is a concern that purified water that is not sufficiently cooled may be supplied as the water discharge progresses.

In addition, in order to supply a sufficient amount of cold-water, purified water flowing along the flow path must be sufficiently cooled. To this end, it is desirable to increase a contact area between the flow path and a cooling member. However, since the flow path is generally provided as a cylindrical pipe, there is a limit to increasing in the contact area.

Korean Patent Registration Document No. 10-1435108 discloses a direct cooling-type module using a thermoelectric element for a water purifier. Specifically, a direct cooling-type module having a structure capable of cooling water in a direct water form and discharging water by using a cooling flow block in which a space is formed inside and through which purified water can flow, and a thermoelectric element coupled with the cooling flow block is disclosed.

However, the direct cooling-type module disclosed in the above-mentioned prior document is arranged such that the thermoelectric element, the cooling flow block, and the heat dispassion plate positioned between them are stacked in the thickness direction. Therefore, the direct cooling-type module disclosed in the above-mentioned prior document does not provide a method for preventing an increase in the volume of the water purifier.

In addition, the cooling flow path block disclosed by the above prior art document is provided in the form of a tank. Therefore, it is difficult to completely exclude a situation in which newly introduced purified water and previously introduced cold-water are mixed, thereby increasing the temperature.

Korean Patent Laid-Open Document No. 10-2017-0083399 discloses a cooling unit using ice storage heat. Specifically, disclosed is a cooling unit having a structure capable of cooling and discharging purified water flowing in a cold-water tube coil using a thermoelectric element.

By the way, the above prior art document is configured such that the cooling housing accommodating the cold-water pipe coil is in contact with the cold block and the thermoelectric element through the cold block. That is, heat-exchange between many components must be performed to cool the water flowing in the cold-water tube coil. Therefore, it is difficult to immediately cool the purified water, and there is also a risk that heat loss will occur in the process of performing heat-exchange between multiple of components.
Korean Patent Registration Document No. 10-1435108 (2014.08.29.)
Korean Patent Laid-Open Document No. 10-2017-008339 (2017.07.18.)

### DISCLOSURE

### Technical Problem

The present disclosure is to solve the above problems, and it is an object of the present disclosure to provide a cooling device having a structure capable of cooling and discharging a fluid without a process of storing the fluid and a water purifier including the same.

Another object of the present disclosure is to provide a cooling device having a structure capable of increasing heat-exchange time to improve cooling efficiency, and a water purifier including the same.

Another object of the present disclosure is to provide a cooling device having a structure capable of increasing a contact area between a member in which a fluid flows and a member for cooling the fluid to improve cooling efficiency, and a water purifier including the same.

Another object of the present disclosure is to provide a cooling device having a structure capable of discharging a sufficient amount of cold-water during one water discharge, and a water purifier including the same.

Another object of the present disclosure is to provide a cooling device having a structure capable of improving assembly convenience, and a water purifier including the same.

The technical problems of the present disclosure are not limited to the above-mentioned technical problems, and other technical problems not mentioned will be clearly understood by those skilled in the art to which the present disclosure pertains from the following description.

### Technical Solution

According to an aspect of the present disclosure, there is provided a cooling device including: a cooling flow path through which a fluid flows therein; a cooling frame configured to be in contact with the cooling flow path and exchange heat to cool the fluid flowing in the cooling flow path; and a cooling module configured to be coupled with the cooling frame to receive heat transferred to the cooling frame and cool the cooling frame, wherein the cooling flow path includes a first cooling flow path configured to be wound around the outside of the cooling frame and be fluidly connected to the outside to form one portion of the flow path through which the fluid flows; and a second cooling flow path configured to be wound around the inside of the cooling frame and be fluidly connected to the first cooling flow path and the outside to form the other portion of the flow path through which the fluid flows, wherein a flow path seat accommodating a portion of an outer circumference of the first cooling flow path is configured on an outer circumference of the cooling frame.

In this case, a cooling device may be provided, wherein the flow path seat includes a concave configured to be recessed toward the inside of the cooling frame to at least partially accommodate the first cooling flow path; and a convex configured to be located adjacent to the concave and protrude toward the first cooling flow path.

In addition, a cooling device may be provided, wherein the cooling frame is configured to extend to have a height in a first direction, and the concave and the convex are formed in plural, and the plurality of concaves and convexes are alternately disposed on the outer circumference of the cooling frame along the first direction.

In this case, a cooling device may be provided, wherein the cooling frame includes a cooling body configured to extend along the first direction, and the plurality of concaves and convexes are alternately disposed along the first direction between a first end and a second end of the colling body in an extension direction.

In addition, a cooling device may be provided, wherein the plurality of concaves and convexes are alternately disposed between a first end opposite to the cooling module and a second end among respective ends of the cooling frame in an extension direction, and the concaves or the convexs disposed closest to the second end are spaced apart from the second end by a predetermined distance.

In this case, a cooling device may be provided, wherein the cooling frame is configured to extend along a first direction, and the concave is configured to extend in a spiral shape axially in the first direction along the outer circumference of the cooling frame.

In addition, a cooling device may be provided, wherein the cooling frame includes: a cooling body configured to extend in a first direction and have the flow path seat formed on an outer circumference thereof; and an accommodation space formed inside the cooling body, wherein the flow path seat is also formed in an inner circumference of the cooling body surrounding the accommodation space in a radial direction to accommodate a portion of an outer circumference of the second cooling flow path.

In this case, a cooling device may be provided, wherein the cooling frame includes a cooling body configured to extend in a first direction and have the flow path seat formed on the outer circumference thereof to wind the first cooling flow path; and an accommodation space configured inside the cooling body to accommodate the second cooling flow path.

In addition, a cooling device may be provided, wherein the first cooling flow path is configured to extend in a spiral shape and be elastically coupled with the outer circumference of the cooling body in a radially inward direction, the second cooling flow path is configured to extend in a spiral shape and be elastically coupled with an inner circumference of the cooling body in a radially outward direction, and the first cooling flow path and the second cooling flow path are disposed to face each other with the cooling body interposed therebetween in a radial direction.

In this case, a cooling device may be provided, wherein the first cooling flow path includes an outer flow path configured to be located radially outward and extend in a spiral shape; and an inner flow path configured to be located between the outer flow path and the outer circumference of the cooling body, be accommodated in the flow path seat, and have a radially outward side in contact with the outer flow path.

In addition, a cooling device may be provided, wherein the outer flow path is configured such that the diameter of its cross-section in a first direction is greater than the diameter in a second direction, and the outer flow path is configured to be in contact with the inner flow path along the second direction.

In this case, a cooling device may be provided wherein the outer flow path is in at least partially surface contact with the inner flow path, and the inner flow path is in at least partially surface contact with an inner circumference of the cooling body.

In addition, a cooling device may be provided wherein the fluid is introduced into one of the first cooling flow path and the second cooling flow path, and is discharged from the other of the first cooling flow path and the second cooling flow path.

In this case, a cooling device may be provided wherein the cooling frame extends in a first direction, and the introduced fluid flows so that a direction in which the fluid flows is converted at least once along the first direction.

In addition, according to an aspect of the present disclosure, there is provided a water purifier including an inlet flow path configured to be fluidly connected to the outside to receive a fluid; a cooling device configured to be fluidly connected to the inlet flow path to cool the received fluid; and an outlet flow path configured to be fluidly connected to the cooling device to discharge the cooled fluid to the outside, wherein the cooling device includes a cooling flow path configured to be fluidly connected to each of the inlet flow path and the outlet flow path; a cooling frame configured to be in contact with the cooling flow path and exchange heat to cool the fluid flowing in the cooling flow path; and a cooling module configured to be coupled with the cooling frame to receive heat transferred to the cooling frame and cool the cooling frame, wherein the cooling flow path includes a first cooling flow path configured to be wound around the outside of the cooling frame and be fluidly connected to one of the inlet flow path and the outlet flow path; and a second cooling flow path configured to be wound around the inside of the cooling frame and be fluidly connected to the other of the inlet flow path and the outlet flow path and the first cooling flow path, wherein a flow path seat at least partially accommodating the first cooling flow path is configured on an outer circumference of the cooling frame.

In this case, a water purifier may be provided wherein the cooling frame is configured to extend along a first direction, and the first cooling flow path is configured in a spiral shape axially in the first direction, and wherein the flow path seat includes a concave configured to extend in a spiral shape axially in the first direction and be recessed on the outer circumference of the cooling frame to at least partially accommodate the first cooling flow path.

In addition, a water purifier may be provided wherein the flow path seat is further configured on an inner circumference of the cooling frame, the cooling frame is configured to extend along a first direction, the second cooling flow path is configured in a spiral shape axially in the first direction, and the flow path seat includes a concave configured to extend in a spiral shape axially in the first direction and be recessed on an inner circumference of the cooling frame to at least partially accommodate the second cooling flow path.

### Advantageous Effects

According to the above configuration, the cooling device and the water purifier including the same according to the embodiment of the present disclosure may cool and discharge a fluid without a process of storing the fluid.

The cooling device is provided with a cooling flow path fluidly connected to the outside. The cooling flow path is configured to be wound around the cooling frame and exchange heat with a cooling frame. The cooling frame is configured to be coupled with the cooling module to exchange heat.

When the cooling module is operated, the heat of the cooling frame and the cooling flow path coupled thereto is transferred to the cooling module. Accordingly, fluid flowing along the cooling flow path may also be cooled while transferring heat to the cooling module. That is, the cooling process of the fluid may be performed while the fluid flows along the cooling flow path.

Therefore, the introduced fluid may be flowed, cooled and discharged without having a separate configuration for storing and cooling the fluid. Accordingly, the cooling device and the water purifier may be miniaturized, and the cooled fluid may be rapidly discharged and provided to the user.

In addition, according to the above configuration, the cooling device and the water purifier including the same according to the embodiment of the present disclosure may increase heat-exchange time to improve cooling efficiency.

The cooling flow path may include a plurality of flow paths. In an embodiment, the cooling flow path may include a first cooling flow path wound around an outer circumference of the cooling frame and a second cooling flow path wound around an inner circumference of the cooling frame. The first cooling flow path and the second cooling flow path are fluidly connected to each other. The fluid introduced into one cooling flow path may flow out through the other cooling flow path.

The first cooling flow path may be divided into a plurality of portions. In an embodiment, the first cooling flow path includes an inner flow path that is in direct contact with the outer circumference of the cooling frame to exchange heat and an outer flow path that is wound around the inner flow path radially outside the inner flow path to indirectly exchange heat with the outer circumference of the cooling frame. That is, the first cooling flow path surrounds the cooling frame with a plurality of layers and flows along the cooling frame multiple times to exchange heat.

The second cooling flow path is fluidly connected to the first cooling flow path. The fluid flowing along the first cooling flow path and cooled, or the fluid introduced from the outside may flow along the second cooling flow path and be cooled by heat-exchange with the inner circumference of the cooling frame.

That is, the introduced fluid may flow along the cooling flow path extending across the inner and outer circumferences of the cooling frame and sufficiently exchange heat. Accordingly, the time for cooling the fluid is increased, and the cooling efficiency of the fluid may be improved.

In addition, according to the above configuration, the cooling device and the water purifier including the same according to the embodiment of the present disclosure may increase a contact area between a member in which a fluid flows and a member for cooling the fluid to improve cooling efficiency.

In an embodiment, at least one of the inner and outer flow paths constituting the first cooling flow path may be configured in an elliptical shape in which the length of the diameter in one direction is longer than the length of the diameter in the other direction. In the embodiment, one side where the outer flow path and the inner flow path are in contact with each other or one side where the inner flow path is in contact with an outer circumference of the cooling frame may be configured as a smooth curved surface corresponding to the major axis.

Therefore, the outer flow path and the inner flow path or the inner flow path and the outer circumference of the cooling frame may be in surface contact, so that a contact area may be increased. Accordingly, the contact area between the outer flow path, the inner flow path, and the cooling frame may be increased, thereby improving the cooling efficiency of the fluid.

In an embodiment, a flow path seat may be formed on an outer circumference or an inner circumference of the cooling frame. The flow path seat includes a concave recessed and a convex surrounding the concave. The concave accommodates an inner flow path or a second cooling flow path. The concave may be configured to correspond to the shape of the inner flow path or the second cooling flow path, and the convex may be in surface contact with the inner flow path or the second cooling flow path accommodated in the concave.

Therefore, the contact area between the inner flow path and the outer circumference of the cooling frame or the second cooling flow path and the inner circumference of the cooling frame may be increased, thereby improving the cooling efficiency of the fluid.

In addition, according to the above configuration, the cooling device and the water purifier including the same according to the embodiment of the present disclosure may discharge a sufficient amount of cold-water during one water discharge.

As described above, the cooling flow path may include a first cooling flow path wound around the outer circumference of the cooling frame and a second cooling flow path wound around the inner circumference of the cooling frame. In addition, the first cooling flow path may include an inner flow path directly in contact with the outer circumference of the cooling frame and an outer flow path wound around the inner flow path.

The first cooling flow path and the second cooling flow path are fluidly connected to each other. The fluid introduced into one of the first cooling flow path and the second cooling flow path may be discharged to the outside through the other one. That is, the introduced fluid may be discharged to the outside after passing through all the first cooling flow path and the second cooling flow path and cooling.

Therefore, the fluid as much as the volume of a first cooling hollow formed in the first cooling flow path and a second cooling hollow formed in the second cooling flow path may be cooled at the same time and discharged continuously. Therefore, a sufficient amount of cold-water may be discharged during one water discharge.

In addition, according to the above configuration, the cooling device and the water purifier including the same according to the embodiment of the present disclosure may improve assembly convenience.

As described above, as the flow path seat is provided, even if the diameter of the first cooling flow path is reduced, a sufficient contact area for heat-exchange may be secured. Therefore, the diameter of the first cooling flow path is reduced, and the first cooling flow path may be more easily wound around the outer circumference of the cooling frame.

Therefore, the assembly convenience of the cooling flow path and the cooling frame may be improved.

It should be understood that the effects of the present disclosure are not limited to the above-described effects, and all effects that may be inferred from the construction of the invention described in the detailed description or the claims of the present disclosure are included.

### DESCRIPTION OF DRAWINGS

FIG. 1 is a block diagram illustrating a configuration of a water purifier according to an embodiment of the present disclosure.

FIG. 2 is a perspective view illustrating a cooling device according to an embodiment of the present disclosure.

FIG. 3 is an exploded perspective view illustrating the cooling device of FIG. 2.

FIG. 4 is an exploded perspective view illustrating a frame of the cooling device of FIG. 2.

FIG. 5 is an exploded perspective view illustrating a cooling module of the cooling device of FIG. 2.

FIG. 6 is a perspective view illustrating a cooling frame of the cooling device of FIG. 2.

FIGS. 7 and 8 are a cross-sectional view A-A of the cooling frame of FIG. 6 and a cross-sectional view A-A of the cooling frame according to a modified embodiment.

FIG. 9 is a perspective view illustrating a cooling flow path of the cooling device of FIG. 2.

FIG. 10 is a plan view (a) and a bottom view (b) illustrating the cooling flow path of FIG. 9.

FIG. 11 is an exploded perspective view illustrating the cooling flow path of FIG. 9.

FIG. 12 is a cross-sectional perspective view C-C illustrating the cooling flow path of FIG. 9.

FIGS. 13 and 14 are perspective views (a), a cross-sectional view C-C (b), and a cross-sectional view D-D (b) of the flow path formed inside the cooling device of FIG. 2.

### DETAILED DESCRIPTION OF THE EMBODIMENTS

Hereinafter, embodiments of the present disclosure will be described in detail with reference to the accompanying drawings so that those skilled in the art can easily implement them. The present disclosure may be implemented in various different forms and is not limited to the embodiments described herein. In order to clearly explain the present disclosure, parts irrelevant to the description are omitted in the drawings, and the same or similar components are denoted by the same reference numerals throughout the entire specification.

The words and terms used in this specification and the claims are not interpreted as limited to ordinary or dictionary meanings, but should be interpreted as meanings and concepts consistent with the technical idea of the present disclosure according to the principle in which the inventor can define the terms and concepts in order to best explain their invention.

Therefore, the embodiments described in this specification and the configurations illustrated in the drawings correspond to a preferred embodiment of the present disclosure and do not all represent the technical idea of the present disclosure, so the corresponding configurations may be various equivalents and modifications to replace them at the time of filing the present disclosure.

In the following description, in order to clarify the features of the present disclosure, some components may be omitted.

The term “communication” used in the following description means that one or more members are connected to each other in fluid communication. In an embodiment, the communication may be formed by a member such as a pipe, a tube, or a conduit. In the following description, communication may be used in the same sense that one or more members are “fluidly connected” to each other.

The term “electrical connection” used in the following description means that one or more members are connected to each other to transfer a current or electric signal. In an embodiment, the electrical connection may be formed in the form of a wire by a wire member or wireless such as Bluetooth, Wi-Fi, and RFID. In an embodiment, the electrical connection may include the meaning of “communication”.

The term “fluid” as used in the following description refers to any type of material that flows by external forces and may deform shape or volume, etc. In one embodiment, the fluid may be a liquid such as water or a gas such as air.

The terms “upper side”, “lower side”, “left side”, “right side”, “front side”, and “rear side” used in the following description will be understood with reference to the coordinate system shown throughout the accompanying drawings.

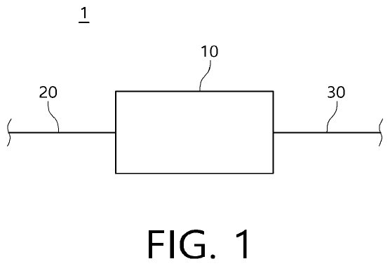

Referring to FIG. 1, a configuration of a water purifier 1 including a cooling device 10 according to an embodiment of the present disclosure and a communication relationship with the outside are disclosed in block diagram.

The water purifier 1 may be fluidly connected to the outside and receive unfiltered fluid, for example, raw water. The water purifier 1 may include any means for filtering the unfiltered fluid, for example, a filter. The fluid introduced into the water purifier 1 may pass through any above means and be filtered.

In addition, the water purifier 1 may include any means for heating or cooling the filtered fluid. The filtered fluid may be adjusted a temperature desired by the user and then discharged to the outside and provided to the user.

To this end, the water purifier 1 may be fluidly connected to the outside and include any means for heating or cooling the filtered fluid.

In an illustrated embodiment, the water purifier 1 includes a cooling device 10, an inlet flow path 20, and an outlet flow path 30.

The cooling device 10 is configured to cool the fluid filtered by a filter (not shown) provided in the water purifier 1. The cooling device 10 may exchange heat with the filtered fluid to cool the fluid. The cooled fluid may flow out to the outside and be provided to the user.

The cooling device 10 may be provided in any form for cooling the filtered fluid. The cooling device 10 may be electrically connected to an external power source (not shown) to receive power necessary for operation. Although not shown, the water purifier 1 may further include an input unit (not shown) that receives a control signal for the operation of the cooling device 10.

Detailed descriptions of each configuration of the cooling device 10 and the process by which the fluid is introduced, cooled, and then discharged will be described later.

The cooling device 10 is fluidly connected to the outside of the water purifier 1 through the inlet flow path 20. In addition, the cooling device 10 is fluidly connected to the outside of the water purifier 1 through the outlet flow path 30.

The inlet flow path 20 is fluidly connected to the outside to receive the unfiltered fluid. The inlet flow path 20 is fluidly connected to the filter (not shown) and the cooling device 10 in turn. The fluid introduced through the inlet flow path 20 may flow into the cooling device 10 after passing through a filter (not shown).

The outlet flow path 30 is fluidly connected to the outside to transfer the fluid passing through the filter (not shown) and the cooling device 10 to the outside. The outlet flow path 30 fluidly connects the cooling device 10 to the outside.

The inlet flow path 20 and the outlet flow path 30 may be provided in any form that may fluidly connect the cooling device 10 to the outside of the water purifier 1. In an embodiment, the inlet flow path 20 and the outlet flow path 30 may be provided in the form of pipes, respectively. In the embodiment, the inlet flow path 20 and the outlet flow path 30 may be provided with valves configured to operate in various forms to control the inflow and outflow of fluids.

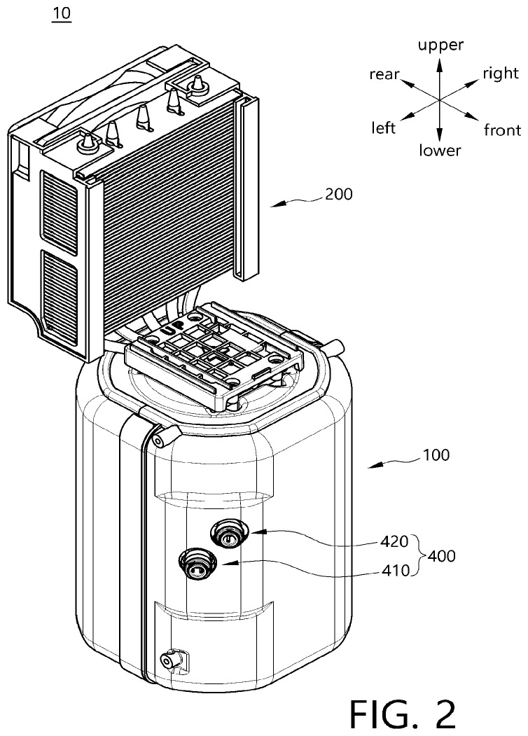

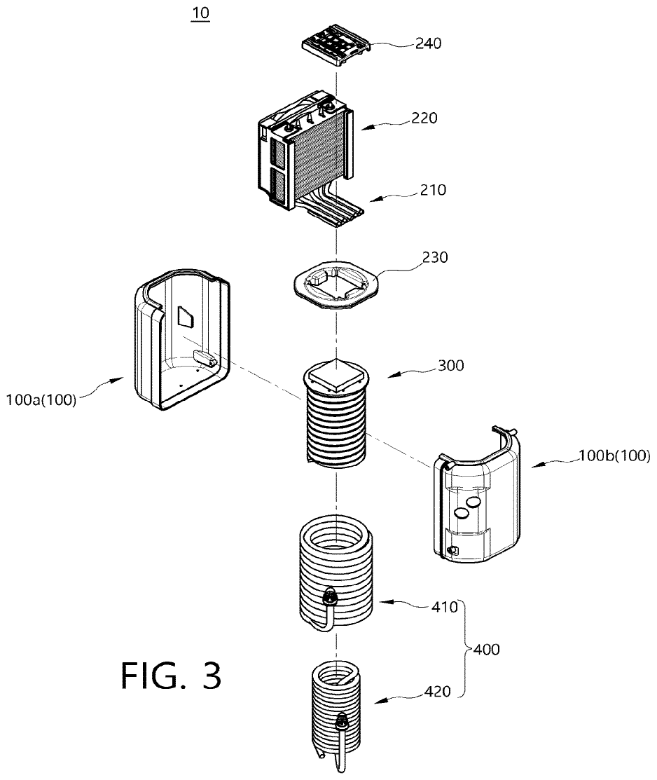

Referring to FIGS. 2 and 3, a cooling device 10 according to an embodiment of the present disclosure is shown.

The cooling device 10 is accommodated inside the water purifier 1 and is fluidly connected to the inlet flow path 20 and the outlet flow path 30. The cooling device 10 may cool the fluid introduced along the inlet flow path 20. The cooled fluid may be discharged along the outlet flow path 30.

The cooling device 10 according to an embodiment of the present disclosure may be configured not to include a separate configuration for storing the fluid. In other words, the cooling device 10 according to an embodiment of the present disclosure may be formed in a direct water type. That is, the fluid introduced along the inlet flow path 20 may be discharged to the outlet flow path 30 immediately after flowing through the cooling device 10.

Therefore, a separate configuration for storing the introduced fluid or the cooled fluid is not required, making it possible to miniaturize the cooling device 10 and the water purifier 1 including the same.

In addition, the cooling device 10 according to an embodiment of the present disclosure may be configured to increase the contact area between a configuration for forming the fluid flow path and a configuration for cooling the fluid. Accordingly, even if the volume of the configuration for forming the fluid flow path is reduced, the fluid may be sufficiently cooled and then flowed out to the outside. As a result, the cooling efficiency of the fluid by the cooling device 10 may be improved.

Furthermore, the cooling device 10 according to the embodiment of the present disclosure may be configured such that the configuration for forming the fluid flow path and the configuration for cooling the fluid are heat-exchanged multiple times. Therefore, the fluid introduced into the cooling device 10 is heat-exchanged with the configuration for cooling the fluid multiple times, so the cooling efficiency of the fluid may be further improved.

In the embodiment shown in FIGS. 2 to 3, the cooling device 10 includes a frame 100, a cooling module 200, a cooling frame 300, and a cooling flow path 400.

The frame 100 forms a portion of the outer shape of the cooling device 10. A space may be formed inside the frame 100 to accommodate a portion of the configuration of the cooling device 10. In the illustrated embodiment, the cooling frame 300 and the cooling flow path 400 are accommodated in the space of the frame 100.

As will be described later, the cooling frame 300 is configured to exchange heat with the fluid and cool it. In addition, the cooling flow path 400 is configured to directly or indirectly wind around the cooling frame 300 and exchange heat with the cooling frame 300.

Accordingly, the frame 100 may be formed of an insulating or heat-retaining material to prevent unnecessary heat-exchange between the cooling frame 300 and the cooling flow path 400 coupled thereto and the outside.

The frame 100 is coupled with the cooling module 200. The space of the frame 100 and the cooling frame 300 accommodated therein may exchange heat with the cooling module 200. In an illustrated embodiment, the frame 100 is coupled with the cooling module 200 at one end thereof in a height direction, that is, an upper end.

The frame 100 is coupled with the cooling frame 300. As described above, the cooling frame 300 is accommodated in the space of the frame 100.

The frame 100 is coupled with the cooling flow path 400. As described above, the cooling flow path 400 is accommodated in the space of the frame 100. In addition, the end of the cooling flow path 400 may penetrate the frame 100 and be exposed to the outside. The inlet flow path 20 and the outlet flow path 30 may be introduced into the cooling flow path 400 or may be discharged from the cooling flow path 400 through the end of the cooling flow path 400.

The frame 100 may be coupled with the cooling module 200 and may be any shape capable of accommodating the cooling frame 300 and the cooling flow path 400. In an illustrated embodiment, the frame 100 has a columnar shape with the space formed therein, a circular cross-section, and a height in the vertical height.

The frame 100 may be formed of a plurality of portions. In an illustrated embodiment, the frame 100 may be formed of a first frame 100a forming a left portion and a second frame 100b forming a right portion. The first frame 100a and the second frame 100b may be detachably coupled with each other. Accordingly, the cooling module 200, the cooling frame 300, and the cooling flow path 400 may be easily coupled with and detached from the frame 100.

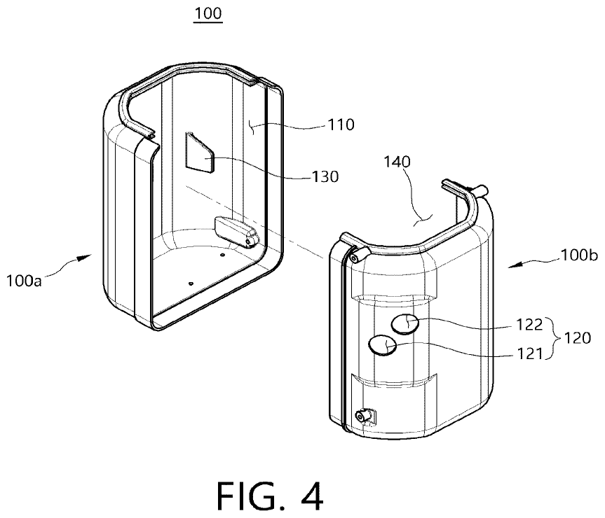

In an embodiment shown in FIG. 4, the frame 100 includes a frame space 110, a communicator 120, a support rib 130, and a cooling opening 140.

The frame space 110 is the space formed inside the frame 100. A portion of the frame space 110 is formed inside the first frame 100a, and the remaining portion of the frame space 110 is formed inside the second frame 100b. When the first frame 100a and the second frame 100b are coupled with each other, the portion of the frame space 110 and the remaining portion of the frame space 110 communicate with each other.

The frame space 110 may have a shape corresponding to the shape of the frame 100. In an illustrated embodiment, the frame space 110 is formed as a cylindrical space having a circular cross-section and a height in the vertical height similar to the frame 100.

The frame space 110 is defined surrounded by the frame 100. In this case, a portion of the frame space 110 may be open to communicate with the outside.

In an illustrated embodiment, the lower side and the radial direction of the frame space 110 are surrounded by the frame 100 and closed. An upper side of the frame space 110 may be opened to form a passage through which the cooling module 200 is coupled with the cooling frame 300. In addition, the communicator 120 is formed in the second frame 100b surrounding the frame space 110 on the right side, so that the frame space 110 may communicate with the outside through the communicator 120.

The frame space 110 accommodates the cooling frame 300 and the cooling flow path 400. The cooling frame 300 may be coupled with the cooling module 200 and exchange heat while accommodated in the frame space 110. In addition, the cooling flow path 400 may be accommodated in the frame space 110 while being coupled with the cooling frame 300, and the end portion in the extension direction thereof may communicate with the outside through the communicator 120.

The frame space 110 may be maintained in a state of being insulated from the outside. In other words, the frame space 110 and the outside of the frame 100 may be configured not to arbitrarily exchange heat. Accordingly, unnecessary heat-exchange between the cooling frame 300 and the cooling flow path 400 accommodated in the frame space 110 may be prevented, thereby improving the cooling efficiency of the fluid.

To this end, the frame space 110 may be filled with a material having a low heat transfer rate, such as foamed Styrofoam. In addition, as described above, the frame 100 itself may be formed of a material having a low heat transfer rate.

The frame space 110 communicates with the outside through the communicator 120. In addition, the frame space 110 communicates with the outside through the cooling opening 140.

The communicator 120 connects one side of the frame space 110 to the outside. In an illustrated embodiment, the communicator 120 communicates the frame space 110 with the outside in the radial direction.

The communicator 120 is formed in the frame 100. In an embodiment, the communicator 120 may be formed through the frame 100. In an illustrated embodiment, the communicator 120 is configured to penetrate the side surface of the second frame 100b located on the right side. Alternatively, the communicator 120 may be configured to penetrate the side surface of the first frame 100a or may be configured to penetrate the side surfaces of the first and second frames 100a and 100b, respectively.

The communicator 120 is coupled with the cooling flow path 400. The cooling communicators 413 and 423 of the cooling flow path 400 may be coupled with the communicator 120 and exposed to the outside of the frame 100. In an embodiment, the cooling communicators 413 and 423 may be coupled with the communicator 120 through.

The communicators 120 may be formed in plural. The plurality of communicators 120 may be disposed at different locations and may be coupled with the plurality of cooling communicators 413 and 423, respectively. In an illustrated embodiment, the communicator 120 is provided with two, including a first communicator 121 formed at a lower left side and a second communicator 122 located at an upper right side.

The first communicator 121 is coupled with the first cooling communicator 413. The first cooling communicator 413 may penetrate the first communicator 121 and be exposed to the outside. The first cooling communicator 413 is fluidly connected to one of the inlet flow path 20 and the outlet flow path 30.

The second communicator 122 is coupled with the second cooling communicator 423. The second cooling communicator 423 may penetrate the second communicator 122 and be exposed to the outside. The second cooling communicator 423 is fluidly connected to the other of the inlet flow path 20 and the outlet flow path 30.

The first and second communicators 121 and 122 may have shapes corresponding to the first and second cooling communicators 413 and 423. In an illustrated embodiment, the first and second communicators 121 and 122 are formed in a disk-shaped space having a circular cross-section and having a thickness in the radial direction.

The support rib 130 supports the cooling frame 300 and the cooling flow path 400 accommodated in the frame space 110. The support rib 130 may prevent the cooling frame 300 and the cooling flow path 400 from shaking.

The support rib 130 is located in the frame space 110. Specifically, the support rib 130 is configured to protrude radially inwardly from the inner surface of the frame 100 surrounding the frame space 110 in the radial direction.

As will be described later, the cooling frame 300 and the cooling flow path 400 are coupled so that a portion of the cooling flow path 400 is wound around the outer circumference of the cooling frame 300. In addition, the cooling frame 300 and the cooling flow path 400 coupled with each other are located adjacent to the center of the frame space 110. Accordingly, the support rib 130 may be said to support the cooling frame 300 and the cooling flow path 400 in the radial direction.

The support rib 130 may extend in the height direction of the frame 100, in the illustrated embodiment, in the vertical height. The support rib 130 is provided in plural, and the plurality of support ribs 130 may be disposed at different locations on the inner surface of the frame 100.

In an embodiment illustrated in FIG. 4, the support rib 130 is shown as being provided on the first frame 100a in a single number, but the support rib 130 may be provided in plural on the first frame 100a and the second frame 100b, respectively.

The cooling opening 140 communicates the other side of the frame space 110 with the outside. In an illustrated embodiment, the cooling opening 140 communicates the frame space 110 with the outside in an upper direction, that is, the direction toward the cooling module 200.

The cooling module 200 may be partially accommodated in the frame space 110 through the cooling opening 140. Accordingly, the cooling module 200 may be coupled with the cooling module 200 accommodated in the frame space 110 to exchange heat.

The cooling opening 140 may be configured to be surrounded by the first and second frames 100a and 100b constituting the frame 100. In an illustrated embodiment, the left side of the cooling opening 140 is defined to be surrounded by the upper side of the first frame 100a, and the right side of the cooling opening 140 is defined to be surrounded by the right side of the second frame 100b.

The cooling opening 140 forms a passage through which a portion of the cooling module 200 pass and is accommodated into the frame space 110. The cooling opening 140 is closed by the heat-receiving plate 210 of the cooling module 200 and the coupling housing 230 that supports it. The heat-receiving plate 210 may be accommodated in the cooling opening 140 through an opening formed inside the coupling housing 230.

The cooling opening 140 may be any shape that may be closed by the heat-receiving plate 210 and the coupling housing 230. In an illustrated embodiment, the cooling opening 140 is a disk or cylinder shape that has a circular cross-section corresponding to the shape of the coupling housing 230 and has a thickness in the vertical height.

In this case, the diameter of the cross-section of the cooling opening 140 may be formed to be less than or equal to the diameter of the cross-section of the frame space 110. Furthermore, the diameter of the cross-section of the cooling opening 140 may be less than or equal to the outer diameter of the cooling flow path 400 wound around the cooling frame 300. Therefore, any deviation of the cooling frame 300 or the cooling flow path 400 coupled therewith through the cooling opening 140 may be prevented.

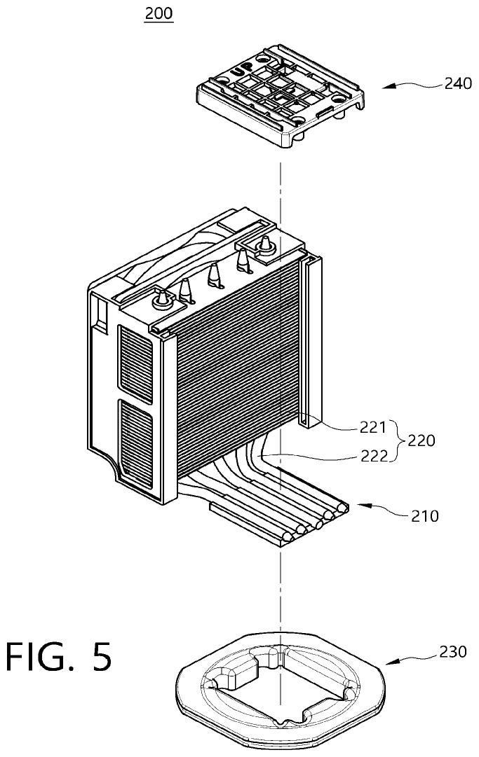

Referring to FIG. 5, the cooling device 10 according to an embodiment of the present disclosure includes a cooling module 200.

The cooling module 200 exchanges heat with the cooling frame 300 to receive heat from the cooling frame 300. Accordingly, the cooling frame 300 and the cooling flow path 400 coupled with the cooling frame 300 may be cooled. As a result, the cooling module 200 may receive heat from the fluid flowing in the cooling flow path 400 and cool the fluid. The cooling module 200 may discharge the transferred heat to the outside.

The cooling module 200 is coupled with the frame 100. Some configurations of the cooling module 200 may be accommodated in the frame space 110 and coupled with the cooling frame 300. The above-mentioned some configurations of the cooling module 200 may be in contact with the cooling frame 300 to exchange heat.

Another configurations of the cooling module 200 are located outside the frame 100. In an illustrated embodiment, the other configuration of the cooling module 200 is located on the upper side of the frame 100. The other configuration of the cooling module 200 may be configured to release the heat received by the above-mentioned some configurations to the outside.

The cooling module 200 may be electrically connected to an external power source (not shown) and a control module (not shown). The cooling module 200 may be operated by receiving power from an external power source (not shown). In addition, the operation of the cooling module 200 may be controlled according to the control information applied by the control module (not shown).

The cooling module 200 may be provided in any form that may exchange heat with the cooling frame 300, the cooling flow path 400 coupled with the cooling frame 300, and the fluid flowing therein.

In an embodiment illustrated in FIG. 5, the cooling module 200 includes a heat-receiving plate 210, a radiator 220, a coupling housing 230, and a heat transfer 240.

The heat receiving plate 210 is a portion where the cooling module 200 is coupled with the cooling frame 300. In an embodiment, the heat receiving plate 210 may be in contact with the cooling plate 320 of the cooling frame 300 and exchange heat with the cooling frame 300. The heat-receiving plate 210 is configured to receive heat from the cooling frame 300.

The heat-receiving plate 210 may be formed of a material having high thermal conductivity. In the embodiment, the heat-receiving plate 210 may be formed of aluminum (Al), stainless steel (SUS), copper (Cu), or an alloy material thereof.

The heat-receiving plate 210 forms the above-described some configurations of the frame 100. The heat-receiving plate 210 is accommodated in the frame space 110.

The heat-receiving plate 210 may be formed in a shape corresponding to the shape of the cooling plate 320. In the illustrated embodiment, the heat-receiving plate 210 is formed in a rectangular plate shape.

The heat-receiving plate 210 is coupled with the fin assembly 221 through the heat pipe 222. The heat transferred to the heat-receiving plate 210 may be released to the outside through the heat pipe 222 and the fin assembly 221.

The heat-receiving plate 210 is coupled with the coupling housing 230. The heat-receiving plate 210 may penetrate an opening (drawing symbol omitted) formed inside the coupling housing 230.

The radiator 220 is configured to exchange heat with the heat-receiving plate 210 and receive heat from the heat-receiving plate 210. The radiator 220 may be configured to release the received heat to the outside of the cooling module 200. To this end, the radiator 220 is located outside the frame 100.

The radiator 220 includes a portion that is coupled with the heat-receiving plate 210 and receives heat therefrom and another portion that releases the received heat to the outside. In the illustrated embodiment, the radiator 220 includes a fin assembly 221 that releases the received heat to the outside and a heat pipe 222 that is coupled with the heat-receiving plate 210.

The fin assembly 221 is coupled with the heat pipe 222 and releases the heat transferred through the heat pipe 222, that is, the heat transferred from the heat-receiving plate 210, to the outside. The fin assembly 221 may be formed by stacking a plurality of fins. In this case, the plurality of fins may be deposed to be spaced apart from each other along the stacking direction.

The heat pipe 222 is coupled with the heat-receiving plate 210 and the fin assembly 221 respectively. The heat of the heat-receiving plate 210 may be transferred to the fin assembly 221 through the heat pipe 222. That is, the heat pipe 222 mediates the heat transfer between the heat-receiving plate 210 and the fin assembly 221.

The heat pipe 222 may be formed of a material having high thermal conductivity. In the illustrated embodiment, the heat pipe 222 may be formed of aluminum, stainless steel, copper, or an alloy material thereof.

A plurality of heat pipes 222 may be provided. The plurality of heat pipes 222 may be spaced apart from each other and may be coupled with the heat-receiving plate 210 and the fin assembly 221, respectively. In the illustrated embodiment, five heat pipes 222 are provided and spaced apart from each other in the left and right directions.

The coupling housing 230 is a portion where the cooling module 200 is coupled with the frame 100. The coupling housing 230 covers the cooling opening 140 of the frame 100 and is coupled with the frame 100.

The coupling housing 230 is coupled with the heat-receiving plate 210. An opening is formed inside the coupling housing 230 so that the heat-receiving plate 210 may be inserted or be coupled with it through. The heat-receiving plate 210 may be coupled with and in contact with the cooling plate 320 of the cooling frame 300 accommodated in the frame space 110 through the opening.

The cooling opening 140 may be sealed by the coupling housing 230 and the heat-receiving plate 210 coupled therewith to block any communication between the frame space 110 and the outside.

The heat transfer 240 serves to exchange heat with the cooling frame 300, the cooling flow path 400 coupled with the cooling frame 300, and the fluid flowing in the cooling flow path 400. When the heat transfer 240 is operated, heat may be moved from the cooling frame 300, the cooling flow path 400, and the fluid toward the cooling module 200. Accordingly, the fluid may be cooled.

The heat transfer 240 is coupled with the heat-receiving plate 210 and the heat pipe 222. In the illustrated embodiment, the heat transfer 240 is disposed to cover the heat-receiving plate 210 and the heat pipe 222 from the upper side. In other words, the heat transfer 240 is disposed to face the cooling frame 300 with the heat-receiving plate 210 and the heat pipe 222 interposed therebetween.

The heat transfer 240 may be provided in any form capable of forming a flow of heat along a first direction. In an embodiment, the heat transfer 240 may be provided in the form of a thermoelement. In the embodiment, the heat transfer 240 may be operated by being electrically connected to an external power source (not shown) or a control module (not shown).

The process of forming a heat flow by the heat transfer 240 is a well-known technology, so a detailed description thereof will be omitted.

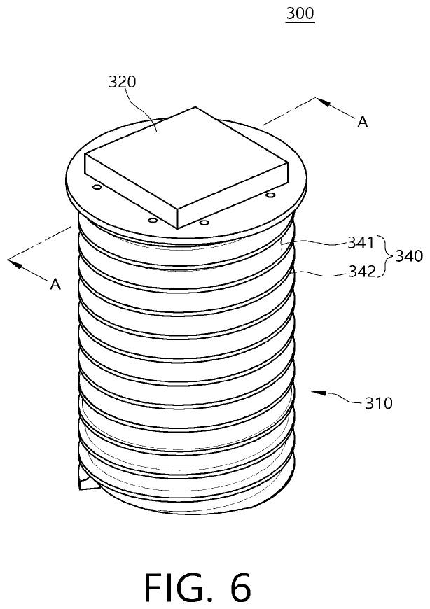

Referring to FIGS. 6 to 8, the cooling device 10 according to an embodiment of the present disclosure includes a cooling frame 300.

The cooling frame 300 is coupled with the cooling flow path 400 to exchange heat with the cooling flow path 400 and the fluid flowing in the cooling flow path 400. The cooling frame 300 may receive heat from the cooling flow path 400 and the fluid.

The cooling frame 300 is coupled with the cooling module 200 and configured to exchange heat. The heat transferred to the cooling frame 300 may be transferred to the cooling module 200 and be released to the outside of the cooling device 10. In the illustrated embodiment, the upper side of the cooling frame 300 may be coupled with the heat-receiving plate 210 to exchange heat.

The cooling frame 300 is accommodated in the frame 100. Specifically, the cooling frame 300 is accommodated in the frame space 110. The cooling frame 300 is supported by each configuration of the frame 100. In the illustrated embodiment, the lower side of the cooling frame 300 may be supported by the lower inner surface of the frame 100. In addition, the radial direction of the cooling frame 300 may be supported by the support rib 130.

The cooling frame 300 may be formed in a shape corresponding to the shape of the frame 100. In the illustrated embodiment, the cooling frame 300 has a cylindrical shape having a circular cross-section and having a height in the vertical height.

A space (i.e., a flow path seat 340 to be described later) that at least partially accommodates a cooling flow path 400 is formed on the outer periphery of the cooling frame 300 according to an embodiment of the present disclosure. The cooling flow path 400 may be accommodated in the space and be in surface contact with the outer circumference of the cooling frame 300.

As the cooling flow path 400 is accommodated in the space and coupled with the cooling frame 300, even if the outer diameter of the cooling flow path 400 is reduced, fluid flowing inside the cooling frame 300 may be sufficiently cooled with the cooling frame 300. Accordingly, productivity of the cooling flow path 400 is improved, and the cooling device 10 and the water purifier 1 including the same may be miniaturized.

The cooling frame 300 may be formed of a material having high thermal conductivity. In the illustrated embodiment, the cooling frame 300 may be formed of aluminum, stainless steel, copper, or an alloy material thereof.

In an illustrated embodiment, the cooling frame 300 includes a cooling body 310, a cooling plate 320, an accommodation space 330, and a flow path seat 340.

The cooling body 310 forms a body of the cooling frame 300. The cooling flow path 400 is wound around the cooling body 310. A flow path seat 340 is formed on the outer circumference of the cooling body 310 to support at least a portion of the wound cooling flow path 400 and be in surface contact therewith.

The cooling body 310 may have a shape corresponding to the shape of the frame 100 or the cooling frame 300. In the illustrated embodiment, the cooling body 310 has a cylindrical shape with a circular cross-section and a height in the vertical height.

Among the ends of the cooling body 310 in the extension direction, one end toward the cooling module 200, in the illustrated embodiment, the upper end is coupled with the cooling plate 320.

The cooling plate 320 is a portion where the cooling frame 300 is coupled with the cooling module 200. The cooling plate 320 is coupled with the heat-receiving plate 210 of the cooling module 200 and may exchange heat. The heat of the cooling flow path 400 and the fluid flowing therein may be sequentially transferred to the cooling module 200 through the cooling body 310 and the cooling plate 320.

The cooling plate 320 is coupled with the cooling body 310. In the illustrated embodiment, the cooling plate 320 is coupled with and in contact with the upper end of the cooling body 310 to exchange heat. In an embodiment, the cooling plate 320 may be integrally formed with the cooling body 310.

The cooling plate 320 may have a shape corresponding to the shape of the heat-receiving plate 210. In the illustrated embodiment, the cooling plate 320 is formed in a rectangular plate shape with a rectangular cross-section and a thickness in the vertical height. In the embodiment, the cooling plate 320 may be formed to have a cross-sectional area smaller than the cross-sectional area of the cooling body 310.

The accommodation space 330 is a space formed inside the cooling body 310. The accommodation space 330 accommodates another portion of the cooling flow path 400. Another portion of the cooling flow path 400 accommodated in the accommodation space 330 may be in contact with the inner circumference of the cooling body 310.

The accommodation space 330 may have a shape corresponding to the shape of the cooling body 310. In the illustrated embodiment, the accommodation space 330 is configured as a cylindrical space with a circular cross-section and a height in the vertical direction.

The accommodation space 330 is defined to be surrounded by the inner circumference of the cooling body 310. In the illustrated embodiment, the upper side of the accommodation space 330 is surrounded by the upper inner surface of the cooling body 310. The radial direction of the accommodation space 330 is surrounded by the radial inner surface of the cooling body 310. The lower side of the accommodation space 330 is open.

Another portion of the cooling flow path 400 may be accommodated in the accommodation space 330 through the opened lower side. Another portion of the cooling flow path 400 may be in contact with the radial inner surface of the cooling body 310 surrounding the accommodation space 330 and exchange heat.

Another potion of the cooling flow path 400 accommodated in the accommodation space 330 may be disposed to face the portion of the cooling flow path 400 wound around the outer circumference of the cooling body 310 with the outer circumference of the cooling body 310 interposed therebetween.

The flow path seat 340 is formed on the outer surface or the inner surface of the cooling body 310 to at least partially accommodate the cooling flow path 400. The flow path seat 340 includes a space for accommodating the cooling flow path 400 and a surface surrounding the space. The cooling flow path 400 accommodated in the flow path seat 340 may be in surface contact with the surface.

Therefore, even if the area of the outer circumference of the cooling flow path 400 is not increased, the contact area between the cooling flow path 400 and the cooling frame 300 may be increased. Accordingly, the diameter of the cooling flow path 400 is reduced, thereby improving the processing convenience and miniaturizing the size of the cooling device 10.

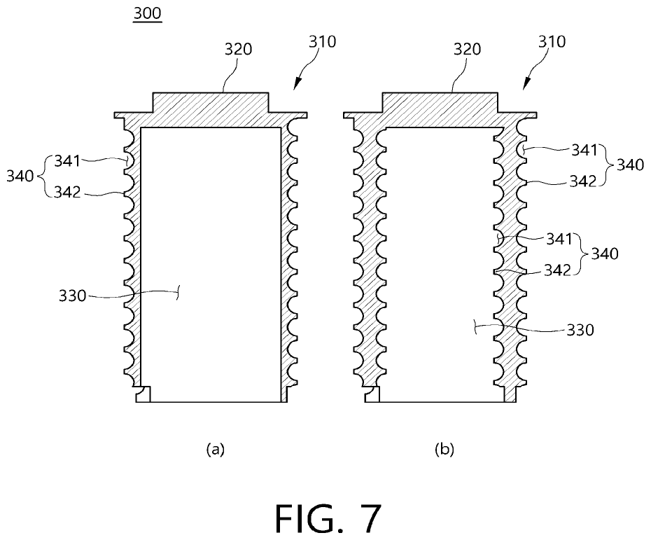

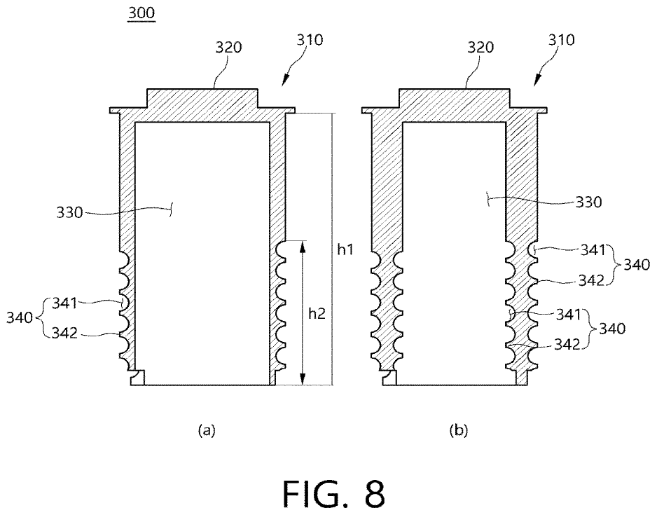

In an embodiment illustrated in FIGS. 7 and 8, the flow path seat 340 includes a concave 341 and a convex 342.

The concave 341 is a space formed by being radially recessed in a first direction on the surface of the cooling body 310. The concave 341 may be opened radially in a second direction to accommodate the cooling flow path 400.

The concave 341 may be formed in a shape corresponding to the shape of the cooling flow path 400. In the illustrated embodiment, the concave 341 may be formed to be rounded so as to be convex toward the first direction, and may be formed open toward the second direction.

The outer surface of the cooling body 310 encompassing the concave 341 may be defined as the convex 342.

The convex 342 encompasses the concave 341 in the height direction of the cooling body 310, that is, in the up and down direction in the illustrated embodiment. The convex 342 may be in contact with the cooling flow path 400 accommodated in the concave 341. In an embodiment, the convex 342 may be in surface contact with the cooling flow path 400.

The convex 342 may be formed in a shape corresponding to the shape of the cooling flow path 400. In the illustrated embodiment, the convex 342 may be formed in the form of a curved surface encompassing the concave 341 from the upper side and the lower side, respectively.

The concave 341 and the convex 342 may be formed in plural. The plurality of concaves 341 and convexs 342 may be alternately formed in the outer circumference of the cooling body 310 along the height direction of the cooling body 310.

Alternatively, the concave 341 and the convex 342 may be provided in a single number and may extend in a helix along the outer circumference of the cooling body 310. That is, assuming that the concave 341 and the convex 342 are one configuration, the concave 341 and the convex 342 extend in a spiral direction around the outer circumference of the cooling body 310.

In any case, it is sufficient that the concave 341 accommodates the cooling flow path 400, and the convex 342 may be in surface contact with the accommodated cooling flow path 400.

The flow path seat 340 may be formed on at least one of an outer surface or an inner surface of the cooling body 310.

In the illustrated embodiment in (a) of FIG. 7, the flow path seat 340 is formed on an outer circumferential surface of the cooling body 310. In the illustrated embodiment in (b) of FIG. 7, the flow path seat 340 is formed not only on the outer circumferential surface of the cooling body 310 but also on an inner circumferential surface of the cooling body 310, that is, on the surface surrounding the accommodation space 330.

In the embodiment, it will be understood that the flow path seat 340 formed on the inner circumferential surface of the cooling body 310 at least partially accommodates the cooling flow path 400 accommodated in the accommodation space 330 and makes surface contact therewith.

Although not show, embodiments in which the flow path seat 340 is formed only on the inner circumferential surface of the cooling body 310 may also be considered.

Meanwhile, the flow path seat 340 may be formed on one or more of the outer surface or the inner surface of the cooling body 310 only to a specific height of the cooling body 310.

In the embodiment shown in (a) of FIG. 8, the flow path seat 340 is formed on the outer circumferential surface of the cooling body 310. In this case, when the height of the cooling body 310 is referred to as the first height H1, the flow path seat 340 may be formed from the lower end of the cooling body 310 only to the second height H2.

In the embodiment, a portion of the cooling flow path 400 wound around the outer circumference of the cooling body 310 may be in contact with the outer circumference of the cooling body 310, and another portion of the cooling body 310 may be in contact with the convex 342 to exchange heat.

In the illustrated embodiment in (b) of FIG. 8, the flow path seat 340 is formed not only on the outer circumferential surface of the cooling body 310 but also on the inner circumferential surface of the cooling body 310, that is, on the surface surrounding the accommodation space 330. In this case, the flow seat 340 may be formed from the lower end of the cooling body 310 only to the second height H2.

In the embodiment, a portion of the cooling flow path 400 wound around the inner circumference of the cooling body 310 may be in contact with the inner circumference of the cooling body 310, and another portion of the cooling body 310 may be in contact with the convex 342 to exchange heat.

As illustrated, the second height H2 may be configured to be less than or equal to the first height H1. In an embodiment, the second height H2 may be less than or equal to half of the first height H1.

That is, in the illustrated embodiment, it may be said that the flow path seat 340 is disposed to be spaced apart from the other end (i.e., the upper end) opposite to the one end (i.e., the lower end) at which the flow path seat 340 starts, by a predetermined distance (i.e., the difference between the first height H1 and the second height H2) among both ends in the height direction of the cooling body 310.

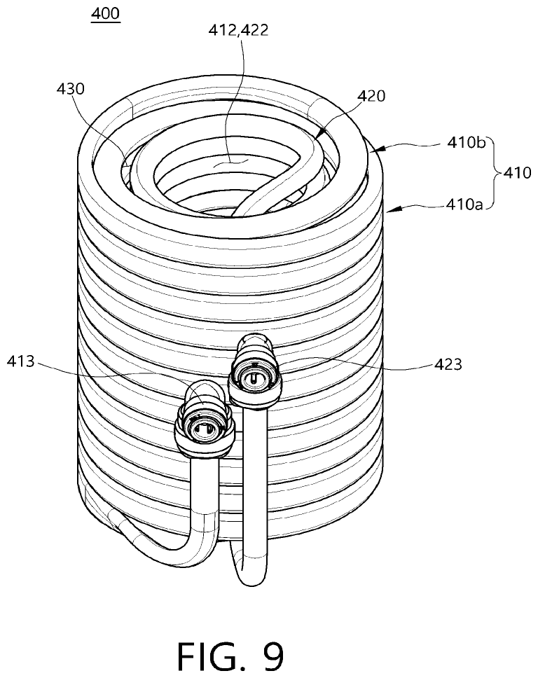

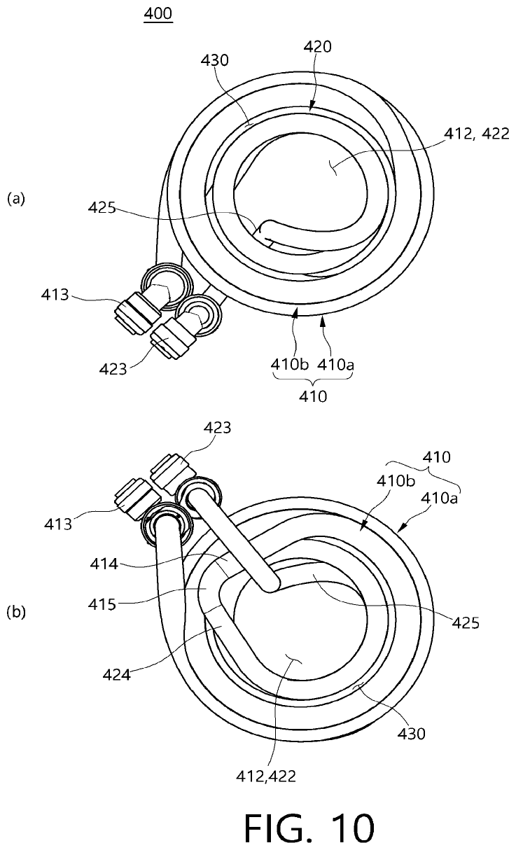

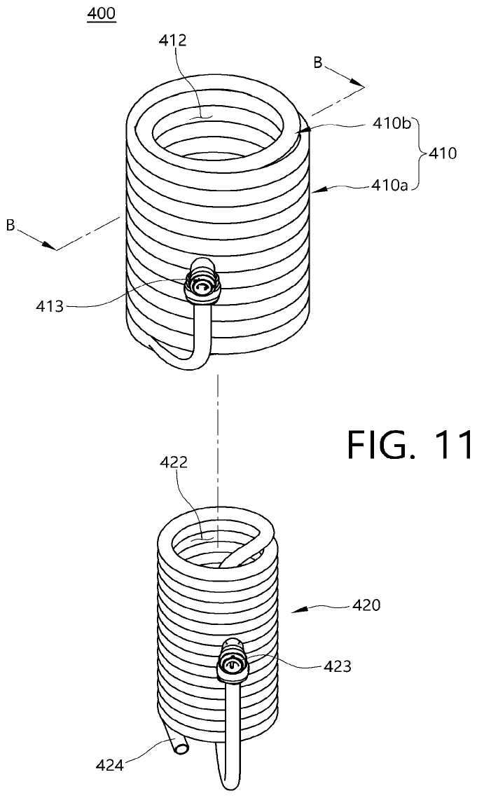

Referring to FIGS. 9 to 12, the cooling device 10 according to an embodiment of the present disclosure includes a cooling flow path 400.

The cooling flow path 400 is fluidly connected to the outside to receive fluid. The fluid flowing in the cooling flow path 400 may be heat-exchanged with the cooling module 200 through the cooling frame 300 and cooled. The cooling flow path 400 may be fluidly connected to the outside and transfer the cooled fluid to the outside.

The cooling flow path 400 is fluidly connected to the inlet flow path 20. A first end of the cooling flow path 400 in the extension direction may be coupled with the inlet flow path 20 and receive fluid from the outside. As described above, the fluid may be a fluid filtered through a filter (not shown).

The cooling flow path 400 is fluidly connected to the outlet flow path 30. A second end of the cooling flow path 400 in the extended direction may be coupled with the outlet flow path 30 and transfer the cooled fluid to the outside.

The cooling flow path 400 may be provided in any form that is fluidly connected to the inlet flow path 20 and the outlet flow path 30, respectively, and form a space in which the fluid flows. In the illustrated embodiment, the cooling flow path 400 is provided in the form of a pipe. In this case, the cooling flow path 400 may extend in the form of a helix.

The cooling flow path 400 is coupled with the frame 100. Specifically, the cooling flow path 400 is accommodated in the frame space 110. Each end of the cooling flow path 400 in the extended direction may be exposed to the outside through the communicator 120 formed in the frame 100. The outer side of the cooling flow path 400 in the radial direction may be supported by the support rib 130.

The cooling flow path 400 is coupled with the cooling frame 300. The cooling flow path 400 may be wound on the outer circumference or inner circumference of the cooling frame 300. The cooling flow path 400 exchanges heat with the cooling module 200 through the cooling frame 300. The heat of the cooling flow path 400 and the fluid flowing therein may be transferred to the cooling module 200 through the cooling frame 300.

The cooling flow path 400 may be divided into a plurality of portions. A first one of the plurality of portions may be fluidly connected to the inlet flow path 20 and receive the fluid from the outside. A second portion of the plurality of portions is fluidly connected to the outlet flow path 30, so that the cooled fluid may discharge to the outside.

In addition, the first one of the plurality of portions constituting the cooling flow path 400 may be wound around the outer circumference of the cooling body 310. The second one of the plurality of portions may be wound around the inner circumference of the cooling body 310.

In this case, the plurality of portions are fluidly connected to each other. The fluid introduced into the first one of the plurality of portions may flow to the second one and be cooled and discharged to the outside.

In the illustrated embodiment, the cooling flow path 400 includes a first cooling flow path 410 wound around the outer circumference of the cooling body 310 and a second cooling flow path 420 wound around the inner circumference of the cooling body 310 accommodated in the accommodation space 330. The first cooling flow path 410 and the second cooling flow path 420 are fluidly connected to each other.

The first cooling flow path 410 forms a portion of the cooling flow path 400. In other words, the first cooling flow path 410 forms one of the inlet flow path and the outlet flow path of the fluid. The first cooling flow path 410 may be wound around the outer circumference of the cooling body 310, and the first cooling flow path 410 and the fluid flowing therein may exchange heat with the cooling body 310 to be cooled. The first cooling flow path 410 may extend in a spiral shape.

The first cooling flow path 410 may be wound around the cooling frame 300 in an arbitrary direction along the height direction of the cooling frame 300. In an embodiment, the first cooling flow path 410 may be wound around the outer circumference of the cooling body 310 in a direction from the lower side to the upper side of the cooling frame 300.

As described above, in an embodiment, the flow path seat 340 may be formed only as much as the second height H2 from the lower side on the outer circumference of the cooling body 310. Accordingly, the first cooling flow path 410 may be coupled with the flow path seat 340 formed on the lower side and may be wound around the cooling body 310.

The first cooling flow path 410 may be divided into a plurality of portions. The plurality of portions may be disposed to overlap along the radial direction. In other words, a first portion of the plurality of portions constituting the first cooling flow path 410 are directly wound around the outer circumference of the cooling body 310, and a second portion of the plurality of portions are indirectly wound around the outer circumference of the cooling body 310 through the first portion.

In the illustrated embodiment, the first cooling flow path 410 includes an outer flow path 410a located radially outside and an inner flow path 410b located radially inside. The inner flow path 410b is directly wound around the outer circumference of the cooling body 310.

The outer flow path 410a is located radially outside the inner flow path 410b, and is indirectly wound around the outer circumference of the cooling body 310 through the inner flow path 410b. At this time, the outer flow path 410a and the inner flow path 410b are fluidly connected to each other.

The practical benefit of distinguishing the outer flow path 410a and the inner flow path 410b lies in the shapes of the outer flow path 410a and the inner flow path 410b.

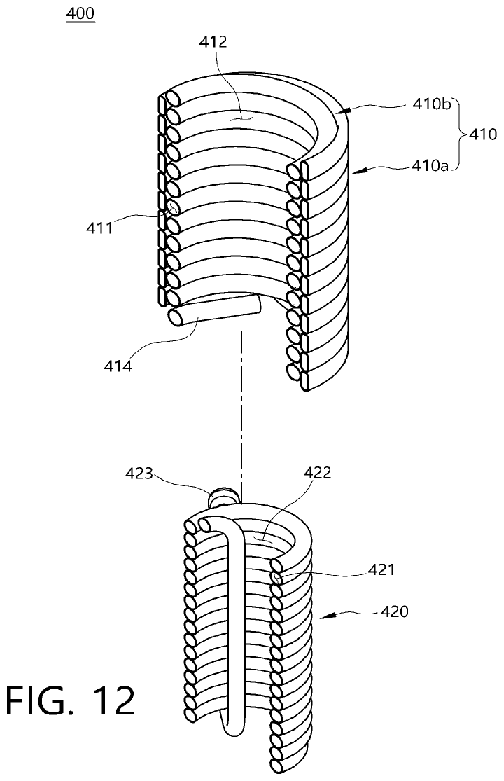

That is, as best illustrated in FIG. 12, the outer flow path 410a may be configured such that its cross-section has a diameter in one direction greater than a diameter in the other direction. In other words, in the illustrated embodiment, the outer flow path 410a is configured to have an elliptical cross-section in which the up and down direction is major axis and the radiation direction is minor axis.

Therefore, one side of each side of the outer flow path 410a toward the inner flow path 410b, that is, the radial inside, is formed with a relatively gentle curved surface. Accordingly, the outer flow path 410a and the inner flow path 410b may be in surface contact.

As a result, the contact area between the outer flow path 410a and the inner flow path 410b may be increased, thereby improving the heat-exchange efficiency of the cooling frame 300 with the fluid flowing in the outer flow path 410a, which is indirectly wound around the cooling body 310.

In addition, the inner flow path 410b may be configured to have a circular cross-section corresponding to the shape of the flow path seat 340. The outer circumference of the inner flow path 410b may be at least partially in surface contact with the convex 342.

Accordingly, the contact area between the inner flow path 410b and the outer circumference of the cooling body 310 may be increased, thereby improving the heat-exchange efficiency of the fluid flowing in the inner flow path 410b and the cooling frame 300.

Although not illustrated, the inner flow path 410b may also be formed to correspond to the shape of the outer flow path 410a. That is, the inner flow path 410b may also be configured such that its cross-section has the diameter in one direction greater than the diameter in the other direction. In the embodiment, the inner flow path 410b may be in surface contact with the outer flow path 410a and the outer circumference of the cooling body 310, respectively.

In the embodiment, the flow path seat 340 may also be changed to correspond to the shape of the inner flow path 410b. Accordingly, the flow path seat 340 and the convex 342 are also in surface contact with the inner flow path 410b, and the cooling efficiency of the fluid flowing inside the inner flow path 410b may be improved.

In an embodiment in which the flow path seat 340 is formed to the first height H1, the inner flow path 410b may be accommodated in the concave 341 extending in a spiral shape along the outer circumference of the cooling body 310 and may be in surface contact with the convex 342.

In an embodiment in which the flow path seat 340 is formed to the second height H2, the inner flow path 410b may be accommodated in the concave 341 to be in surface contact with the convex 342, and may be in line contact with the outer circumference of the cooling body 310 at the remaining height, that is, a height corresponding to the difference between the first height H1 and the second height H2.

In the illustrated embodiment in FIGS. 9 to 12, the first cooling flow path 410 includes a first cooling hollow 411, a first cooling space 412, a first cooling communicator 413, a first connector 414 and a flow path coupler 415.

The first cooling hollow 411 is a space formed inside the first cooling flow path 410. The first cooling hollow 411 is configured to extend along the first cooling flow path 410. Each end of the first cooling hollow 411 may be opened and fluidly connected to another member. In the illustrated embodiment, one end of the first cooling hollow 411 is fluidly connected to the first cooling communicator 413, and the other end of the first cooling hollow 411 is fluidly connected to the second cooling flow path 420.

The first cooling hollow 411 may have a shape corresponding to the shape of the first cooling flow path 410. As described above, the first cooling flow path 410 includes the outer flow path 410a and the inner flow path 410b. Accordingly, the first cooling hollow 411 located inside the outer flow path 410a may be configured such that its cross-section has a diameter in one direction greater than a diameter in the other direction. In addition, the first cooling hollow 411 located inside the inner flow path 410b may have a circular cross-section.

The first cooling space 412 is a space formed radially inwardly of the first cooling flow path 410 extending in a spiral shape. The first cooling space 412 accommodates the cooling frame 300 and the second cooling flow path 420.

The first cooling space 412 may be configured to correspond to the shape of the first cooling flow path 410. In the illustrated embodiment, the first cooling space 412 has a cylindrical shape with a circular cross-section and a height in the up and down direction. The radial direction of the first cooling space 412 is surrounded by the inner flow path 410b. Each end of the first cooling space 412 in the height direction, that is, the upper side and the lower side in the illustrated embodiment, are respectively configured as open.

In this case, the diameter of the cross-section of the first cooling space 412 may be greater than the diameter of the cross-section of the cooling body 310. In the embodiment, the first cooling flow path 410 may be pressurized radially outwardly, and the cooling body 310 may be accommodated after the diameter of the cross-section of the first cooling space 412 is increased. Thereafter, when the pressurized state of the first cooling flow path 410 is released, the diameter of the cross-section of the first cooling space 412 is reduced, so that the inner flow path 410b may be fitted into and coupled with the cooling body 310.

The first cooling communicator 413 is a portion in which the first cooling flow path 410 is fluidly connected to the outside. The first cooling communicator 413 is coupled with the communicator 120 formed in the frame 100 and exposed to the outside of the frame 100. The first cooling communicator 413 is fluidly connected to one end of the first cooling flow path 410 in the extension direction, that is, the left end of the illustrated embodiment.

The first cooling communicator 413 may be fluidly connected to either the inlet flow path 20 or the outlet flow path 30. In an embodiment in which the first cooling communicator 413 is fluidly connected to the inlet flow path 20, the first cooling flow path 410 may form an inlet flow path of the fluid. In an embodiment in which the first cooling communicator 413 is fluidly connected to the outlet flow path 30, the first cooling flow path 410 may form an outlet flow path of the fluid.

The first cooling communicator 413 may be coupled with the first communicator 121. In an embodiment in which the first communicator 121 is penetrated through the frame 100, the first cooling communicator 413 may be coupled with the first communicator 121 through. In the embodiment, the first cooling communicator 413 may be configured to correspond to the shape of the first communicator 121 to close the first communicator 121. Accordingly, arbitrary communication between the frame space 110 and the outside may be blocked.

The first cooling communicator 413 is fluidly connected to the outer flow path 410a. When the first cooling communicator 413 is fluidly connected to the inlet flow path 20, the fluid introduced into the first cooling communicator 413 may flow to the inner flow path 410b through the outer flow path 410a. When the first cooling communicator 413 is fluidly connected to the outlet flow path 30, the fluid introduced into the outer flow path 410a may flow out to the outside through the first cooling communicator 413.

The first connector 414 forms the other end portion of the first cooling flow path 410 in the extended direction. The first connector 414 is a portion in which the first cooling flow path 410 is fluidly connected to the second cooling flow path 420. In the illustrated embodiment, the first connector 414 forms a lower end of the first cooling flow path 410.

Due to the relative positional relationship between the first cooling communicator 413 and the first connector 414, the heat-exchange time between the fluid flowing along the first cooling flow path 410 and the cooling frame 300 may be increased thereby improving the cooling efficiency of the fluid. A detailed description thereof will be given later.

The first connector 414 is fluidly connected to the second connector 424 of the second cooling flow path 420 through the flow path coupler 415.

The flow path coupler 415 fluidly connects the first cooling flow path 410 and the second cooling flow path 420. The flow path coupler 415 is coupled with the first connector 414 of the first cooling flow path 410 and the second connector 424 of the second cooling flow path 420, respectively. The flow path coupler 415 is fluidly connected to the first connector 414 and the second connector 424, respectively.

The flow path coupler 415 may be disposed at a position corresponding to the positions of the first connector 414 and the second connector 424. In the illustrated embodiment, the flow path coupler 415 is located biased to the lower side of the cooling flow path 400.

The second cooling flow path 420 forms the other portion of the cooling flow path 400. In other words, the second cooling flow path 420 forms the other of the inlet flow path and the outlet flow path of the fluid. The second cooling flow path 420 is accommodated in the accommodation space 330. The second cooling flow path 420 may be wound around the inner circumference of the cooling body 310, and the second cooling flow path 420 and the fluid flowing therein may exchange heat with the cooling body 310 to be cooled. The second cooling flow path 420 may extend in a spiral shape.

The second cooling flow path 420 may be wound around the cooling frame 300 in an arbitrary direction along the height direction of the cooling frame 300. In an embodiment, the second cooling flow path 420 may be wound around the outer circumference of the cooling body 310 in a direction from the lower side to the upper side of the cooling frame 300.

As described above, in an embodiment, the flow path seat 340 may be formed only as much as the second height H2 from the lower side on the inner circumference of the cooling body 310. Accordingly, the second cooling flow path 420 may be coupled with the flow path seat 340 formed on the lower side and may be wound around the cooling body 310.

In the illustrated embodiment, the second cooling flow path 420 has a circular cross-section. Alternatively, the shape of the cross-section of the second cooling flow path 420 be configured such that its cross-section has the diameter in one direction greater than the diameter in the other direction, similar to the shape of the cross-section of the outer flow path 410a. In the embodiment, the second cooling flow path 420 is configured to have an elliptical cross-section in which the up and down direction is major axis and the radiation direction is minor axis.

In the embodiment, the second cooling flow path 420 may be in surface contact with the inner circumference of the cooling body 310. In the embodiment, the flow path seat 340 may also be changed to correspond to the shape of the second cooling flow path 420. Accordingly, the flow path seat 340 and the convex 342 are also in surface contact with the second cooling flow path 420, and the cooling efficiency of the fluid flowing inside the second cooling flow path 420 may be improved.

In an embodiment in which the flow path seat 340 is formed to the first height H1, the second cooling flow path 420 may be accommodated in the concave 341 extending in a spiral shape along the inner circumference of the cooling body 310 and may be in surface contact with the convex 342.

In an embodiment in which the flow path seat 340 is formed to the second height H2, the second cooling flow path 420 may be accommodated in the concave 341 to be in surface contact with the convex 342, and may be in line contact with the inner circumference of the cooling body 310 at the remaining height, that is, a height corresponding to the difference between the first height H1 and the second height H2.

In an embodiment illustrated in FIGS. 9 to 12, the second cooling flow path 420 includes a second cooling hollow 421, a second cooling space 422, a second cooling communicator 423, a second connector 424, and a flow path connector 425.

The second cooling hollow 421 is a space formed inside the second cooling flow path 420. The second cooling hollow 421 is configured to extend along the second cooling flow path 420. Each end of the second cooling hollow 421 may be opened and fluidly connected to another member. In the illustrated embodiment, one end of the second cooling hollow 421 is fluidly connected to the second cooling communicator 423, and the other end of the second cooling hollow 421 is fluidly connected to the first cooling flow path 410.

The second cooling hollow 421 may have a shape corresponding to the shape of the second cooling flow path 420. In the illustrated embodiment, the second cooling hollow 421 has a circular cross-section.

The second cooling space 422 is a space formed radially inwardly of the second cooling flow path 420 extending in a spiral shape. The second cooling space 422 provides a space in which the second cooling path 420 may be radially inwardly pressurized and deformed in shape so that it may be accommodated in the accommodation space 330.

The second cooling space 422 may be configured to correspond to the shape of the second cooling flow path 420. In the illustrated embodiment, the second cooling space 422 has a cylindrical shape with a circular cross-section and a height in the up and down direction. The radial direction of the second cooling space 422 is surrounded by the second cooling flow path 420. Each end of the second cooling space 422 in the height direction, that is, the upper side and the lower side in the illustrated embodiment, are respectively configured as open.

In this case, the outer diameter of the cross-section of the second cooling space 422 may be less than the diameter of the cross-section of the accommodation space 330. In the embodiment, the second cooling flow path 420 may be pressurized radially inwardly, and the diameter of the cross-section of the second cooling space 422 may be reduced and then accommodated in the accommodation space 330. Thereafter, when the pressurized state of the second cooling flow path 420 is released, the diameter of the cross-section of the second cooling space 422 may increase, so that the second cooling flow path 420 may be fitted into and coupled with the cooling body 310.

The second cooling communicator 423 is a portion in which the second cooling flow path 420 is fluidly connected to the outside. The second cooling communicator 423 is coupled with the communicator 120 formed in the frame 100 and exposed to the outside of the frame 100. The second cooling communicator 423 is fluidly connected to one end of the second cooling flow path 420 in the extension direction, that is, the left end in the illustrated embodiment.

The second cooling communicator 423 may be fluidly connected to the other of the inlet flow path 20 and the outlet flow path 30. In an embodiment in which the second cooling communicator 423 is fluidly connected to the inlet flow path 20, the second cooling flow path 420 may form an inlet flow path of the fluid. In an embodiment in which the second cooling communicator 423 is fluidly connected to the outlet flow path 30, the second cooling flow path 420 may form a fluid outlet flow path.

The second cooling communicator 423 may be coupled with the second communicator 122. In an embodiment in which the second communicator 122 is penetrated into the frame 100, the second cooling communicator 423 may be coupled with the second communicator 122 through. In the embodiment, the second cooling communicator 423 may be configured to correspond to the shape of the second communicator 122 to close the second communicator 122. Accordingly, arbitrary communication between the frame space 110 and the outside may be blocked.

The second cooling communicator 423 is fluidly connected to the inner flow path 410b of the first cooling flow path 410. When the second cooling communicator 423 is fluidly connected to the inlet flow path 20, the fluid introduced into the second cooling communicator 423 may flow to the inner flow path 410b through the second cooling flow path 420. When the second cooling communicator 423 is fluidly connected to the outlet flow path 30, the fluid introduced into the first cooling flow path 410 may flow to the second cooling flow path 420 by sequentially passing through the outer flow path 410a and the inner flow path 410b.

The second connector 424 forms the other end of the second cooling flow path 420 in the extension direction. The second connector 424 is a portion in which the second cooling flow path 420 is fluidly connected to the inner flow path 410b of the first cooling flow path 410. In the illustrated embodiment, the second connector 424 forms the lower end of the second cooling flow path 420.

The second connector 424 is coupled with and communicates with the flow path coupler 415. Accordingly, the second connector 424 may be fluidly connected to the first connector 414.

The flow path connector 425 fluidly connects the second cooling communicator 423 and the upper portion of the second cooling flow path 420. The flow path connector 425 is coupled with the second cooling communicator 423 and the upper portion of the second cooling flow path 420, respectively. The flow path connector 425 is fluidly connected to the second cooling communication portion 423 and the upper portion of the second cooling flow path 420, respectively.

The flow path connector 425 extends between the second cooling communicator 423 and the upper portion of the second cooling flow path 420. In the illustrated embodiment, one end of the flow path connector 425 is located adjacent to the second cooling communicator 423, which is located biased downward. The other end of the flow path connector 425 is located adjacent to an upper portion of the second cooling flow path 420 located above.

Due to the relative positional relationship between the second cooling communicator 423 and the second connector 424 and the extension direction of the flow path connector 425, the heat-exchange time between the fluid flowing along the second cooling flow path 420 and the cooling frame 300 may be increased thereby improving the cooling efficiency of the fluid. A detailed description thereof will be given later.

The cooling frame seat 430 is a space formed between the first cooling flow path 410 and the second cooling flow path 420. The cooling frame seat 430 is configured such that the first cooling flow path 410 and the second cooling flow path 420 are spaced apart from each other in the radial direction.

The radially outer side of the cooling frame seat 430 is surrounded by the first cooling flow path 410. The radially inside of the cooling frame seat 430 is surrounded by the second cooling flow path 420.

The cooling frame seat 430 may be configured to correspond to the shape of the cooling body 310. In the illustrated embodiment, the cooling frame seat 430 is configured as a space with a ring-shaped cross-section and a height in the vertical direction.

The outer circumference of the cooling body 310 is accommodated in the cooling frame seat 430. Each end of the cooling frame seat 430 in the height direction, that is, the upper and lower ends in the illustrated embodiment, may be opened to form a passage through which the outer circumference of the cooling body 310 is accommodated.

In an embodiment, the external fluid may flow into the second cooling flow path 420 located in the accommodation space 330 and then flow out into the first cooling flow path 410 located outside the cooling frame 300.

As described above, when the first cooling flow path 410 forms an inlet flow path of the fluid, the introduced fluid flows into the outer flow path 410a, which is disposed furthest from the cooling body 310. On the other hand, when the second cooling flow path 420 forms an inlet flow path of the fluid, the introduced fluid flows into the second cooling flow path 420, which is disposed relatively closer to the cooling body 310.

Therefore, when the fluid is introduced through the second cooling flow path 420, the fluid entering the cooling flow path 400 and the cooling frame 300 may exchange heat through a shorter path, thereby improving the cooling efficiency of the fluid.

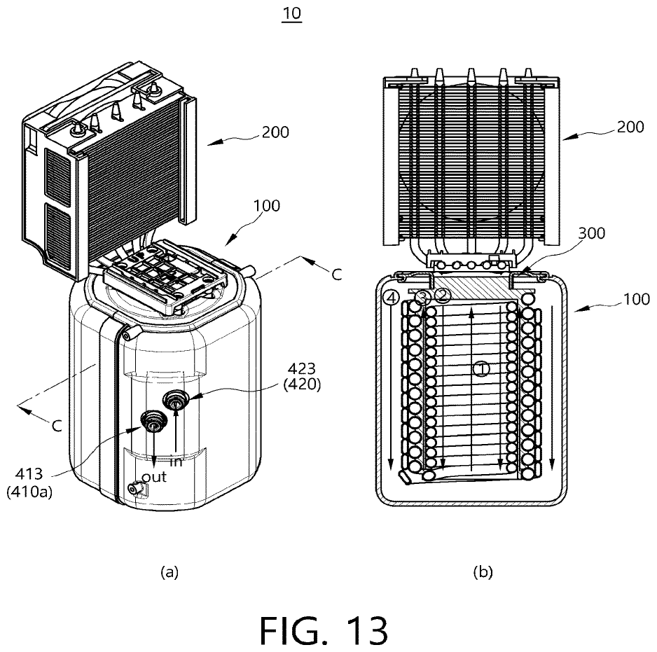

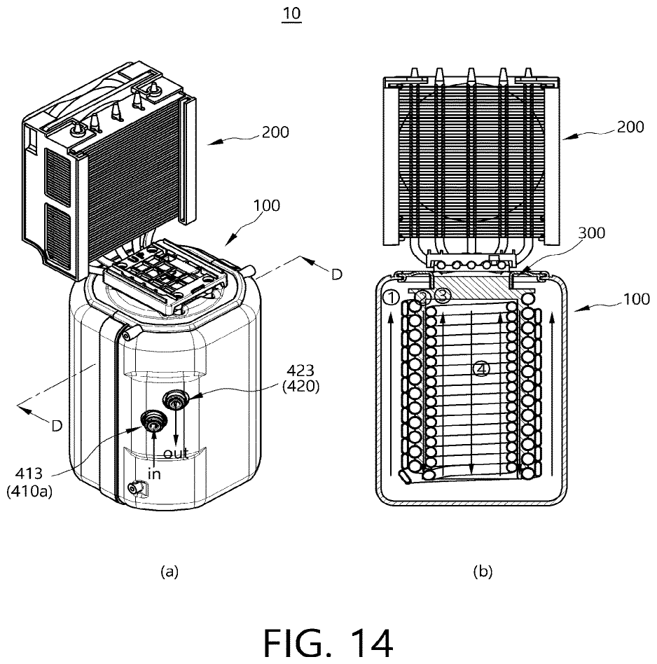

Referring to FIGS. 13 and 14, a fluid flow path formed inside a cooling device 10 according to an embodiment of the present disclosure is illustrated as an example.

As described above, the cooling device 10 is fluidly connected to the inlet flow path 20 and the outlet flow path 30 through the first cooling communicator 413 and the second cooling communicator 423. One of the first cooling communicator 413 and the second cooling communicator 423 may form an inlet flow path of the fluid, and the other of the first cooling communicator 413 and the second cooling communicator 423 may form an outlet flow path of the fluid.

In an embodiment illustrated in FIG. 13, the first cooling communicator 413 is fluidly connected to the outlet flow path 30 to form an outlet passage of the fluid, and the second cooling communicator 423 is fluidly connected to the inlet flow path 20 to form an inlet passage of the fluid.

In the embodiment, the fluid introduced into the second cooling communicator 423 may flow through the second cooling flow path 420 and the first cooling flow path 410 in sequence and then flow out to the outlet flow path 30 through the first cooling communicator 413.

Specifically, the fluid introduced into the second cooling communicator 423 flows to the lower side and flows to the upper end of the second cooling flow path 420 along the flow path connector 425 extending between the lower side and the upper side of the second cooling flow path 420 (\textcircled{1} of (b) in FIG. 13).

The fluid flowing to the upper end of the second cooling flow path 420 flows to the lower side again along the second cooling flow path 420 wound around the inner circumference of the cooling body 310 in a spiral shape and is cooled (\textcircled{2} of (b) in FIG. 13). In this case, the fluid may exchange heat with the inner circumference of the cooling body 310 and be cooled.

The second connector 424 forming the lower end of the second cooling flow path 420 is fluidly connected to the first connector 414 through the flow path coupler 415. The first connector 414 is defined as the lower end of the inner flow path 410b. Accordingly, the fluid introduced into the first connector 414 flows to the upper side along the inner flow path 410b wound around the outer circumference of the cooling body 310 and is cooled again (\textcircled{3} of (b) in FIG. 13). In this case, the fluid may exchange heat with the outer circumference of the cooling body 310 and be cooled.

The upper end of the inner flow path 410b is fluidly connected to the upper end of the outer flow path 410a. In addition, the first cooling communicator 413 forming the outlet passage of the fluid is located lower than the upper end. Accordingly, the fluid flows to the lower side along the outer flow path 410a wound around the inner flow path 410b and is cools again (\textcircled{4} of (b) in FIG. 13). At this time, the fluid may exchange heat with the inner flow path 410b and be cooled.

The cooled fluid flows out to the outlet flow path 30 through the first cooling communicator 413 provided at one end of the outer flow path 410a.

In an embodiment illustrated in FIG. 14, the first cooling communicator 413 is fluidly connected to the inlet flow path 20 to form an inlet passage of the fluid, and the second cooling communicator 423 is fluidly connected to the outlet flow path 30 to form an outlet passage of the fluid.

In the embodiment, the fluid introduced into the first cooling communicator 413 may flow through the outer flow path 410a, the inner flow path 410b, and the second cooling flow path 420 in sequence, and then flow out to the outlet flow path 30 through the second cooling communicator 423.

Specifically, the fluid introduced into the first cooling communicator 413 flows to the lower side and flow into the outer flow path 410a. The fluid flows to the upper side along the outer flow path 410a and is cooled \textcircled{1} of (b) in FIG. 18). At this time, the fluid may exchange heat with the inner flow path 410b and be cooled.

The upper end of the outer flow path 410a is fluidly connected to the upper end of the inner flow path 410b. Accordingly, the fluid flows to the lower side along the inner flow path 410b and is cooled again \textcircled{2} of (b) in FIG. 13). In this case, the fluid may exchange heat with the outer circumference of the cooling body 310 and be cooled.

The first connector 414 fluidly connected to the second connector 424 through the flow path coupler 415 is provided on the lower side of the inner flow path 410b. The fluid flows into the lower side of the second cooling flow path 420 through the flow path coupler 415. The introduced fluid flows to the upper side and is cooled again (\textcircled{3} of (b) in FIG. 13). In this case, the fluid may exchange heat with the inner circumference of the cooling body 310 and be cooled.

The upper end of the second cooling flow path 420 is fluidly connected to the second cooling communicator 423 located relatively lower through the flow path connector 425. Accordingly, the fluid passes through the flow path connector 425 and the second cooling communicator 423 in sequence, and flows out to the outlet flow path 30.

Therefore, the cooling device 10 according to the embodiment of the present disclosure may allow the introduced fluid to be cooled by heat-exchange over multiple times and then flow out. Accordingly, heat-exchange efficiency is improved, and as a result, cooling efficiency of fluids may also be improved.

In addition, even if the diameter of the outer flow path 410a is reduced by the shape of the outer flow path 410a, sufficient cooling efficiency may be expected. Furthermore, the flow path seat 340 is formed on the outer surface or the inner surface of the cooling body 310, so that the area in surface contact with the inner flow path 410b may be increased.

Accordingly, the coupling between the cooling flow path 400 and the cooling frame 300 is facilitated, and heat-exchange efficiency and cooling efficiency may also be improved.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 1: water purifier | 10: cooling device |
| 20: inlet flow path | 30: outlet flow path |
| 100: frame | 100a: first frame |
| 100b: second frame | 110: frame space |
| 120: communicator | 121: first communicator |
| 122: second communicator | 130: support rib |
| 140: cooling opening | 200: cooling module |
| 210: heat-receiving plate | 220: radiator |
| 221: fin assembly | 222: heat pipe |
| 230: coupling housing | 240: heat transfer |
| 300: cooling frame | 310: cooling body |
| 320: cooling plate | 330: accommodation space |
| 340: flow path seat | 341: concave |
| 342: convex | 400: cooling flow path |
| 410: first cooling flow path | 410a: outer flow path |
| 410b: inner flow path | 411: first cooling hollow |
| 412: first cooling space | 413: first cooling communicator |
| 414: first connector | 415: flow path coupler |
| 420: second cooling flow path | 421: second cooling hollow |
| 422: second cooling space | 423: second cooling communicator |
| 424: second connector | 425: flow path connector |
| 430: cooling frame seat | H1: first height |
| H2: second height | |

1. A cooling device, comprising:
a cooling flow path through which a fluid flows therein;
a cooling frame configured to be in contact with the cooling flow path and exchange heat to cool the fluid flowing in the cooling flow path; and
a cooling module configured to be coupled with the cooling frame to receive heat transferred to the cooling frame and cool the cooling frame,
wherein the cooling flow path includes:
a first cooling flow path configured to be wound around the outside of the cooling frame and be fluidly connected to the outside to form one portion of the flow path through which the fluid flows; and
a second cooling flow path configured to be wound around the inside of the cooling frame and be fluidly connected to the first cooling flow path and the outside to form the other portion of the flow path through which the fluid flows,
wherein a flow path seat accommodating a portion of an outer circumference of the first cooling flow path is configured on an outer circumference of the cooling frame.

2. The cooling device of claim 1, wherein the flow path seat includes:
a concave configured to be recessed toward the inside of the cooling frame to at least partially accommodate the first cooling flow path; and
a convex configured to be located adjacent to the concave and protrude toward the first cooling flow path.

3. The cooling device of claim 2, wherein the cooling frame is configured to extend to have a height in a first direction, and
the concave and the convex are formed in plural, and the plurality of concaves and convexes are alternately disposed on the outer circumference of the cooling frame along the first direction.

4. The cooling device of claim 3, wherein the cooling frame includes a cooling body configured to extend along the first direction, and
the plurality of concaves and convexes are alternately disposed along the first direction between a first end and a second end of the colling body in an extension direction.

5. The cooling device of claim 3, wherein the plurality of concaves and convexes are alternately disposed between a first end opposite to the cooling module and a second end among respective ends of the cooling frame in an extension direction, and
the concaves or the convexs disposed closest to the second end are spaced apart from the second end by a predetermined distance.

6. The cooling device of claim 2, wherein the cooling frame is configured to extend along a first direction, and
the concave is configured to extend in a spiral shape axially in the first direction along the outer circumference of the cooling frame.

7. The cooling device of claim 1, wherein the cooling frame includes:
a cooling body configured to extend in a first direction and have the flow path seat formed on an outer circumference thereof; and
an accommodation space formed inside the cooling body,
wherein the flow path seat is also formed in an inner circumference of the cooling body surrounding the accommodation space in a radial direction to accommodate a portion of an outer circumference of the second cooling flow path.

8. The cooling device of claim 1, wherein the cooling frame includes:
a cooling body configured to extend in a first direction and have the flow path seat formed on the outer circumference thereof to wind the first cooling flow path; and
an accommodation space configured inside the cooling body to accommodate the second cooling flow path.

9. The cooling device of claim 8, wherein the first cooling flow path is configured to extend in a spiral shape and be elastically coupled with the outer circumference of the cooling body in a radially inward direction,
the second cooling flow path is configured to extend in a spiral shape and be elastically coupled with an inner circumference of the cooling body in a radially outward direction, and
the first cooling flow path and the second cooling flow path are disposed to face each other with the cooling body interposed therebetween in a radial direction.

10. The cooling device of claim 8, wherein the first cooling flow path includes:
an outer flow path configured to be located radially outward and extend in a spiral shape; and
an inner flow path configured to be located between the outer flow path and the outer circumference of the cooling body, be accommodated in the flow path seat, and have a radially outward side in contact with the outer flow path.

11. The cooling device of claim 10, wherein the outer flow path is configured such that the diameter of its cross-section in a first direction is greater than the diameter in a second direction, and
the outer flow path is configured to be in contact with the inner flow path along the second direction.

12. The cooling device of claim 11, wherein the outer flow path is in at least partially surface contact with the inner flow path, and
the inner flow path is in at least partially surface contact with an inner circumference of the cooling body.

13. The cooling device of claim 1, wherein the fluid is introduced into one of the first cooling flow path and the second cooling flow path, and is discharged from the other of the first cooling flow path and the second cooling flow path.

14. The cooling device of claim 13, wherein the cooling frame extends in a first direction, and
the introduced fluid flows so that a direction in which the fluid flows is converted at least once along the first direction.

15. A water purifier, comprising:
an inlet flow path configured to be fluidly connected to the outside to receive a fluid;
a cooling device configured to be fluidly connected to the inlet flow path to cool the received fluid; and
an outlet flow path configured to be fluidly connected to the cooling device to discharge the cooled fluid to the outside,
wherein the cooling device includes:
a cooling flow path configured to be fluidly connected to each of the inlet flow path and the outlet flow path;
a cooling frame configured to be in contact with the cooling flow path and exchange heat to cool the fluid flowing in the cooling flow path; and
a cooling module configured to be coupled with the cooling frame to receive heat transferred to the cooling frame and cool the cooling frame,
wherein the cooling flow path includes:
a first cooling flow path configured to be wound around the outside of the cooling frame and be fluidly connected to one of the inlet flow path and the outlet flow path; and
a second cooling flow path configured to be wound around the inside of the cooling frame and be fluidly connected to the other of the inlet flow path and the outlet flow path and the first cooling flow path,
wherein a flow path seat at least partially accommodating the first cooling flow path is configured on an outer circumference of the cooling frame.

16. The water purifier of claim 15, wherein the cooling frame is configured to extend along a first direction, and
the first cooling flow path is configured in a spiral shape axially in the first direction, and
wherein the flow path seat includes:
a concave configured to extend in a spiral shape axially in the first direction and be recessed on the outer circumference of the cooling frame to at least partially accommodate the first cooling flow path.

17. The water purifier of claim 15, wherein the flow path seat is further configured on an inner circumference of the cooling frame,
the cooling frame is configured to extend along a first direction,
the second cooling flow path is configured in a spiral shape axially in the first direction, and
the flow path seat includes a concave configured to extend in a spiral shape axially in the first direction and be recessed on an inner circumference of the cooling frame to at least partially accommodate the second cooling flow path.
